(19) United States
(12) Patent Application Publication
(10) Pub. No.: US 2018/0041426 A1
(43) Pub. Date: Feb. 8, 2018

(54) DYNAMIC ROUTE SELECTION FOR ROUTING DATA IN A CONTENT DELIVERY SYSTEM

(71) Applicant: Layer3 TV, Inc., Denver, CO (US)

(72) Inventor: Charles A. Hasek, IV, Denver, CO (US)

(21) Appl. No.: 15/670,890

(22) Filed: Aug. 7, 2017

Related U.S. Application Data
(60) Provisional application No. 62/372,080, filed on Aug. 8, 2016.

(51) Int. Cl. H04L 12/725; H04L 12/707; H04L 29/06; H04L 29/08

(52) U.S. Cl. CPC H04L 45/3065; H04L 67/322; H04L 45/22; H04L 29/06; G06Q 30/00

(57) ABSTRACT

Disclosed herein is content delivery system that delivers content to one or more client devices. The content delivery system is configured to determine which network paths within the content delivery network have performance characteristics that exceed a performance threshold. These paths are then used to deliver content to the client devices.

### CROSS-REFERENCE TO RELATED APPLICATION(S)

This application is a nonprovisional patent application of and claims the benefit of U.S. Provisional Patent Application No. 62/372,080, filed Aug. 8, 2016 and titled “Dynamic Route Selection for Routing Data in a Content Delivery System,” the disclosure of which is hereby incorporated herein by reference in its entirety.

### FIELD

The described embodiments relate generally to a content delivery system. More specifically, the described embodiments are directed to dynamically updating a content delivery path in a content delivery system based on one or more performance characteristics of the various network path segments that make up the content delivery path.

### BACKGROUND

Content delivery systems typically utilize a lot of network bandwidth as they provide content to their subscribers over a given network. In some instances, various portions of the given network may have high latency or low bandwidth which may affect the content provided to the subscribers of the content delivery system. However, the content delivery system may not know or recognize the performance issues with the given network. Additionally, the content delivery system may not be equipped to deal with the performance issues even if they are discovered.

### SUMMARY

Disclosed herein is a content delivery system that delivers content to one or more client devices. In the described embodiments, the content delivery system may provide content to the client device over a network path. In some cases, the network path may be provided by an internet service provider.

However, if at any time it is determined that the network path is underperforming (e.g., the network path has latency or bandwidth issues), the content delivery system may select an alternate path over which the content may be delivered to its client devices. In some embodiments, the alternate path may include network path portions provided by the internet service provider and network path portions that are provided by the content provider.

Accordingly, described herein is a method for delivering content to a client device. According to this method, a client device may collect data about at least a portion of a network path over which content is delivered to the client device. The client device may send or otherwise transmit this data to a data analyzer. The data analyzer may analyze the received data to determine one or more performance parameters of the at least the portion of the network path. When it is determined that the performance parameters of the at least the portion of the network path is below a performance threshold, an alternate network path is selected. The alternate network path comprises a first network path portion from a first provider and a second network path portion from a second provider.

Also described is a content delivery system, comprising a client device communicatively coupled to a first network. The client device may include a network data collection module. The content delivery system may also include a content delivery module that is communicatively coupled to a second network and the first network. The content delivery system also includes a network analyzer configured to receive network data from the network data collection module, and determine, based at least in part, on the network data, a content delivery path. The content delivery path may include network path segments from the first network and network path segments from the second network.

The described embodiments also include a computer-readable storage medium encoding computer-executable instructions which, when executed by a processing unit, performs a method for dynamically selecting a content delivery path. According to this method, performance data about at least a portion of the delivery path is received. The received data is analyzed to determine one or more performance parameters of the at least the portion of the delivery path. When it is determined that the performance parameters of the at least the portion of the delivery path is below a performance threshold, an alternate delivery path is selected. In some embodiments, the alternate delivery path comprises a first path portion from a first provider and a second path portion from a second provider.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A illustrates an example content delivery system for delivering content to one or more client devices;

FIG. 1B illustrates the example content delivery system of FIG. 1A in which additional access points and network paths have been discovered;

FIG. 1C illustrates the example content delivery system of FIG. 1B in which a metrohead of the content delivery system provides service to multiple access points;

FIG. 1D illustrates the example content delivery system of FIG. 1C in which an additional metrohead has been added or is otherwise accessible to at least one access point;

FIG. 2 illustrates a method for determining and selecting a content delivery path in a content delivery system;

FIG. 3 illustrates a method for determining and selecting a content delivery path based, at least in part, on a subscription level of a subscriber to a subscription based content provider; and

FIG. 4 illustrates example components of a computing device that may be part of the content delivery system.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure is directed to a content delivery system that delivers content to a client device over a network. The client device may be any computing or electronic device capable of receiving content over the network. Accordingly, the client device may be a laptop computing device, a desktop computing device, a tablet computing device, an internet-ready television and so on. In some embodiments, the content is provided to the client device by a subscription based content provider. In such instances, the client device may be a set-top box that is provided to a subscriber by the subscription based content provider.

The content delivery system of the present disclosure includes a headend and one or more metroheads. The headend and the metroheads may be associated with particular geographic areas. As such, they may be configured to deliver content to subscribers in those geographic areas.

For example, the headend may process and distribute content to client devices in a first geographic area while a metrohead processes and distributes content to client devices in a second geographic area. The headend and the metroheads may be communicatively coupled together over a network path or a set of network paths. In some embodiments, the network paths utilized by the headend and the metroheads may be built or otherwise provided by the subscription based content provider. As such, the network path utilized by these components may be a closed network or a private network made up of routers, switches, hubs and so on.

The headend, and each of the metroheads, may also be coupled to an open network. As used herein, the term “open network” means a network provided by an internet service provider. The open network may include one or more access points that enable the headend, and each metrohead, to tie into the open network. Each access point in the open network may also be communicatively coupled together by various network paths. The network paths may include routers, switches, hubs and the like. Because the headend and the metroheads are able to tie into the open network via the access points, these components can deliver content to one or more client devices that are also connected to the open network.

For example, the headend may tie into the open network of the internet service provider using a particular access point. The headend may then use a particular network path to deliver content to the client device.

However, in some instances, the open network may have performance issues, such as, for example, bandwidth or latency issues, that could negatively affect the delivery of content to the client devices. In addition, the subscription based content provider may not know or otherwise be aware of such latency or bandwidth issues.

Accordingly, in the embodiments described herein, one or more of the client devices connected to the open network may have an associated data collector. The data collector is configured to receive performance data about the open network. For example, the data collector may periodically test bandwidth or latency of the open network and report the results to the subscription based content provider.

Once the data is received by the subscription based content provider, the data may be analyzed to determine what areas of the open network are performing well, what areas of the open network are not performing well, and so on. For example, the data may indicate that one or more areas or paths of the open network have performance parameters that are below a performance threshold.

If content is being delivered to a client device over those portions of the open network, the quality of the delivered content, and/or the end-user experience may be negatively affected. In order to preserve the quality of the delivered content and avoid the discovered network issues, the subscription based content provider may be able to select alternate network paths that may be used to provide content to the client devices. The alternate network paths may include path segments from the open network and path segments from the closed network. Each of the network path segments may have determined performance parameters that are above a performance threshold.

In some embodiments, the subscription based content provider may provide the collected performance data, or otherwise notify the internet service provider about the detected issues. Once the portions of the open network have been fixed (e.g., the performance parameters exceed the performance threshold), the subscription based content provider may resume delivering content to it client devices over those portions of the open network.

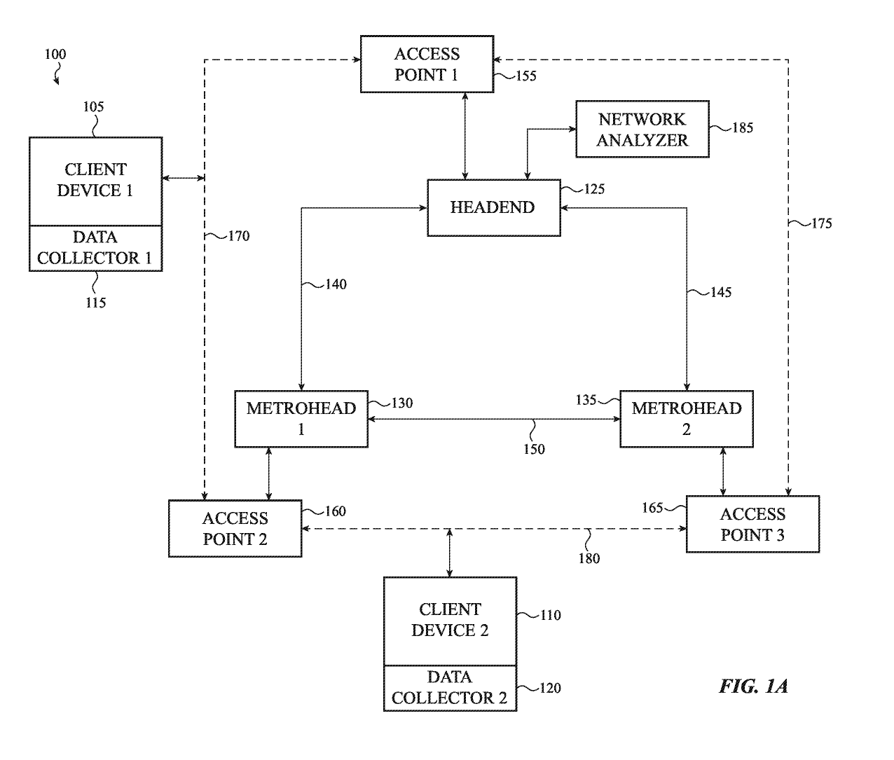

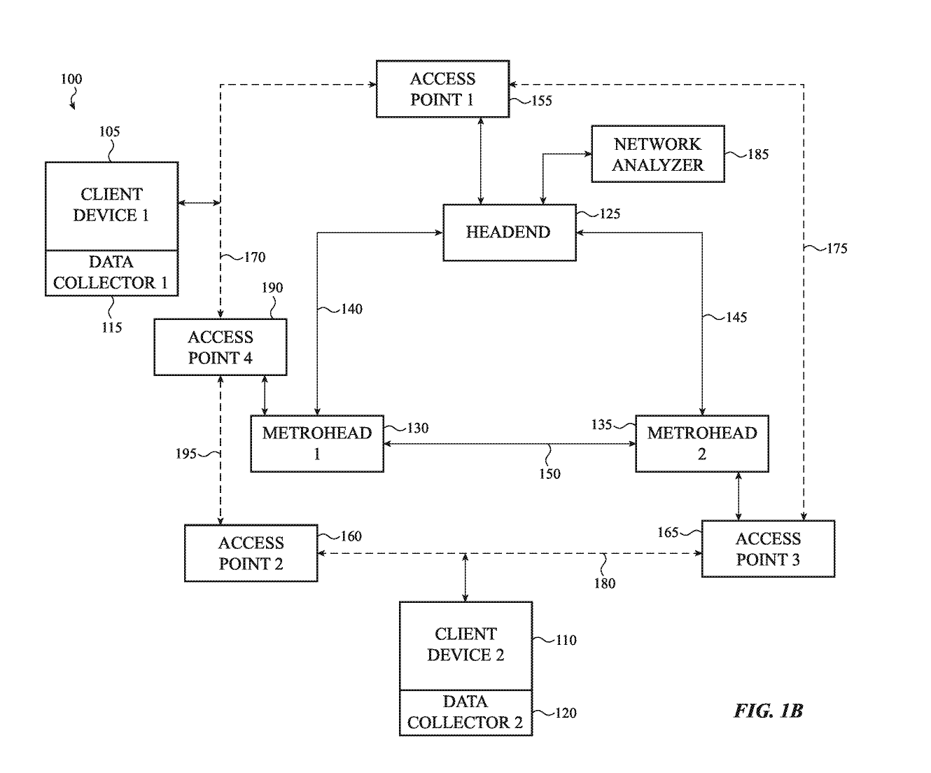

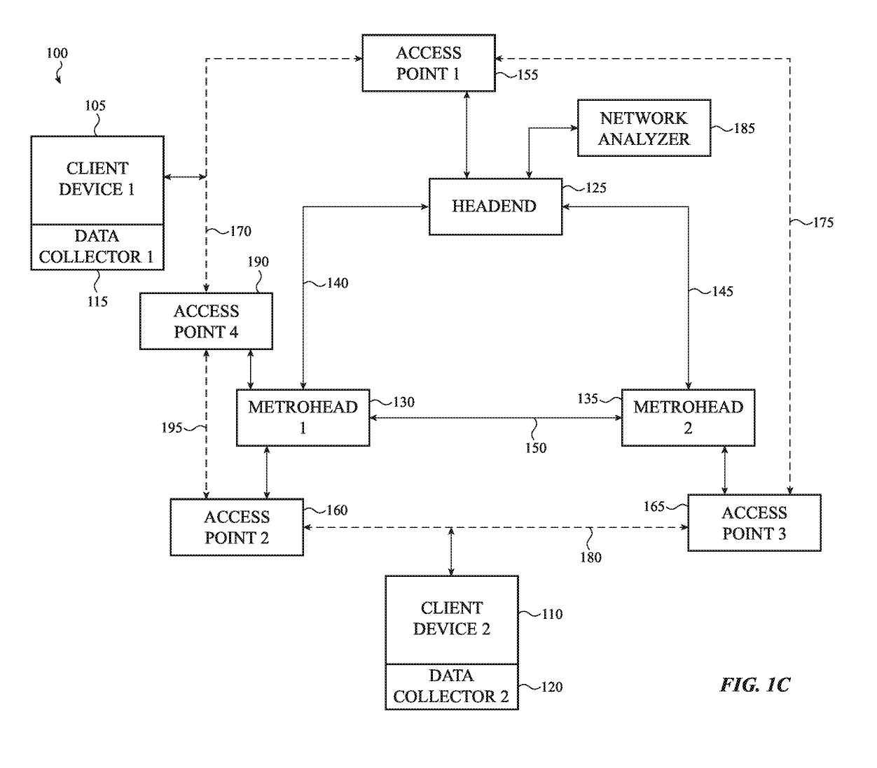

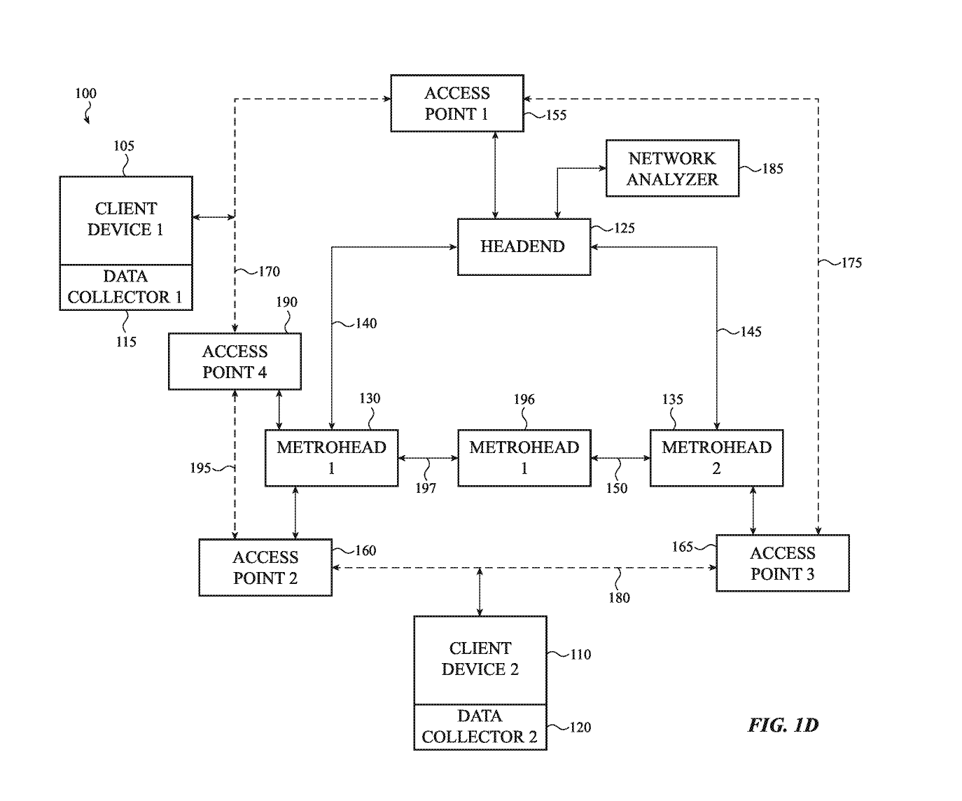

These and other embodiments are discussed in more detail below with reference to FIGS. 1A-4. However, those skilled in the art will readily appreciate that the detailed description given herein with respect to these Figures is for explanatory purposes only and should not be construed as limiting.

FIG. 1A illustrates an example content delivery system 100 according to one or more embodiments of the present disclosure. The content delivery system 100 may be configured to deliver content from a subscription based content provider to one or more client devices. For example, the subscription based content provider may provide books, movies, music, television shows, and the like to one or more client devices that are connected to a network. Although a subscription based content provider is specifically discussed, the embodiments described herein may be used by any content provider. Accordingly, the term “content provider” used herein may encompass both a subscription based content provider and a non-subscription based content provider.

More specifically, the content delivery system 100 may include multiple client devices, such as, for example, Client Device 1 105 and Client Device 2 110. As discussed above, each client device may be any device capable of connecting to, and receiving content over, an internet or network connection. Accordingly, Client Device 1 105 and Client Device 2 110 may be a laptop computing device, a desktop computing device, a tablet computing device, an internet-ready television and so on.

In some implementations, Client Device 1 105 and Client Device 2 110 may be a set-top boxes that are provisioned by the content provider. Although a set-top box is specifically mentioned, one is not required. Further, although two client devices are shown, the content delivery system 100 may include any number of client devices.

Client Device 1 105 and Client Device 2 110 may be located in different geographic areas. However, each of these devices may be customers of the same internet service provider and as such, may be connected to the open network provided by the internet service provider. Additionally, Client Device 1 105 and Client Device 2 110 may be subscribers to the content provider. As such, the content provider may provide content to Client Device 1 105 and Client Device 2 110 over the open network such as will be described in more detail below.

In some embodiments, Client Device 1 105 and Client Device 2 110 each have a network data collection module that collects performance characteristics about the open network. For example, Data Collector 1 115 may be installed, integrated with, or otherwise provided in Client Device 1 105 and Data Collector 2 120 may be installed, integrated with, or otherwise provided in Client Device 2 110. Each of these network data collection modules may test bandwidth and latency of one or more path portions of the open network. This information may then be collected and analyzed by the content provider to determine which areas of the open network are performing well, which areas of the open network are underperforming and/or which additional areas of the open network (if any) may be used to provide content to the client devices.

Although each client device is shown as having a network data collection module, utilization of the network data collection module may be optional. For example, a subscriber of the content provider may “opt in” to have the data collector installed on her client device. In some embodiments, the subscriber may receive a subscription discount or other perks for collecting data about the open network and providing it to the content provider.

The content delivery system 100 also includes a headend 125. The headend 125 processes and distributes content from the content provider to the various client devices in the content delivery system 100. The headend 125 may be associated with a particular geographic region. As such, the headend 125 may be configured to provide content to client devices in and around its associated regions.

The headend 125 may also be associated with various metroheads. Each metrohead may also be associated with a particular geographic region and may have a similar functionality to the headend 125. For example, the content delivery system 100 may include Metrohead 1 130 and Metrohead 2 135. Metrohead 1 130 may be associated with a particular geographic region and may deliver content to various client devices in and around that region. Likewise, Metrohead 2 135 may be associated with another geographic region and may deliver content to various client devices in and around that region. Although the headend 125 and each metrohead may be located in different geographic areas, each of these components may be communicatively coupled together by one or more network paths provided by the content provider.

For example, headend 125 may be connected to Metrohead 1 130 by network path segment 140. Headend 125 may also be connected to Metrohead 2 135 by network path segment 145. In addition, Metrohead 1 130 may be connected to Metrohead 2 135 by network path segment 150. Although certain connection paths are shown, the content delivery system 100 may include various connections paths.

As briefly described above, each of the network path segments between the headend 125 and the metroheads may make up a closed network of the content delivery system 100. Although not shown, each network path segment may include routers, switches, hubs and so on. The headend 125 and each metrohead may use the closed network to share or otherwise distribute content to each other and/or various client devices.

The content delivery system 100 also utilizes a second network to distribute content to Client Device 1 105 and/or Client Device 2 110. Like the closed network, the open network may include various routers, hubs, switches and so on. In some embodiments, the second network is an open network provided by an internet service provider such as described above. For example, Client Device 1 105 and Client Device 2 110 may be connected to one or more routers or endpoints of the open network. Once connected, the headend 125 and/or a metrohead may use the open network to deliver content to Client Device 1 105 and Client Device 2 110.

For example, the headend 125, Metrohead 1 130 and Metrohead 2 135 may each have access points that enable them to tie into the open network provided by the internet service provider. Once these components are tied into the open network, content may be delivered over the open network to Client Device 1 105 and Client Device 2 110.

In the example shown in FIG. 1A, headend 125 may be associated with Access Point 1 155, Metrohead 1 130 may be associated with Access Point 2 160, and Metrohead 2 135 may be associated with Access Point 3 165. Further each of the access points may be communicatively coupled together over various network path segments.

For example, Access Point 1 155 may be communicatively coupled with Access Point 2 160 via network path segment 170. Access Point 1 115 may also be communicatively coupled with Access Point 3 165 over network path segment 175. Additionally, Access Point 2 160 may be communicatively coupled to Access Point 3 165 over network path segment 180.

When a client device requests content from the content provider, the headend (or the metroheads) provide the content over the open network via their respective access points. For example, if Client Device 1 105 is requesting content, the content may be delivered by the headend 125 through Access Point 1 155 and onto network path segment 170.

The content delivery system 100 may also include a network analyzer 185. The network analyzer 185 may receive network performance data from the various network data collection modules such as, for example, Data Collector 1 115 and Data Collector 2 120. Once the data is received, the network analyzer 185 may be able to determine one or more performance parameters of the various path segments of the open network. If some of the network path segments have performance parameters that are below a performance threshold, the network analyzer 185 may be configured to reroute content delivery down different network path segments.

Continuing the example from above, when Client Device 1 105 receives content from headend 125 via Access Point 1 and network path segment 170, Data Collector 1 115 may be configured to collect data about network path segment 170 and/or access point 1 155. This data may then be periodically sent to the network analyzer 185.

Upon receiving the data, the network analyzer 185 may determine that network path segment 170 has performance characteristics that are below a threshold. For example, network path segment 170 may have low bandwidth and/or a high latency—at least between Access Point 1 155 and Client Device 1 105. The performance characteristics may negatively affect the content that is delivered to Client Device 1 105.

The network analyzer 185 may also receive data from a second network data collection module, such as, for example, Data Collector 2 120. Data Collector 2 120 may be in a different geographical location than Data Collector 1 115. As such, Data Collector 2 120 may have performance parameters about different portions of the open network, such as, for example, network path segment 180.

When the network analyzer 185 receives the performance characteristics of the network path segment 180, it may determine that the network path segment 180 has better performance characteristics than the network path segment 170. As such, the network analyzer 185 may reroute content through the better performing network path segment—even if it means that the content traverses a longer path.

For example, and as described above, headend 125 may be configured to provide content to Client Device 1 105 using Access Point 1 155 and network path segment 170. However, the network analyzer 185 may determine, based on data received from Data Collector 1 115, that at least a portion network path segment 170 (e.g., the portion of the network path segment 170 between Access Point 1 155 and Client Device 1 105) has performance characteristics that are below a performance threshold. As such, the content that is being delivered to Client Device 1 105 may be negatively affected. Accordingly, the network analyzer 185 may determine an alternate network path through which the content can be delivered to Client Device 1 105.

The alternate path may include portions of the closed network and portions of the open network. For example, headend 125 may provide the content that is to be delivered to Client Device 1 105 to Metrohead 2 135 over network path segment 145. In other implementations, Metrohead 2 135 may have access to the content that is to be provided to the Client Device 1 105. In either event, once the content is identified, Metrohead 2 135 may access network path segment 180 via Access Point 3 165. The content may then be transmitted to Client Device 1 105 over network path segment 180 and another portion of network path segment 170 (e.g., a portion between Access Point 2 160 and Client Device 1 105 that is not experiencing poor performance characteristics).

In some embodiments, Metrohead 2 135 may be in a different geographic area than Client Device 1 105. As such, the alternate network path selected by the network analyzer 185 may be longer than the initial network path that was utilized to originally deliver content to Client Device 1 105. However, due to the increased performance characteristics of the network path segment 180 versus the network path segment 170, the content may be delivered to Client Device 1 105 at a higher rate and/or quality.

In some embodiments, the network analyzer 185 may be able to predict when certain network path segments will experience performance characteristics that are below a performance threshold. As such, the network analyzer 185 may predictively reroute content to various client devices accordingly. For example, if certain segments of the open network path experience low bandwidth and/or high latency during particular hours of the day, days of the week, weeks of the month, and so on, the network analyzer 185 may proactively reroute content to its client devices in order to avoid low performing network path segments.

In addition, the internet service provider that provides the open network may indicate that certain portions of its network are down, or will be down, such as, for example, for maintenance purposes or repairs. In such cases, the network analyzer 185 may automatically select alternate network paths for client devices that may be affected by the open network outage.

In yet other implementations, the network analyzer 185 may select alternate network paths based on the type of content being delivered to the client device. For example, if high-definition content is being provided to a client device, a first alternate network path may be selected. However, if 4K content is being provided to the client device, a second alternate network path having higher performance characteristics may be selected.

In addition to the examples above, the network analyzer may select alternate network paths based, at least in part, on a subscription level of a given user. For example, a first subscriber who pays a first subscription amount may receive content over network paths that meet or exceed a first performance threshold. Likewise, a second subscriber who pays a second subscription amount may receive content over network paths that meet or exceed a second performance threshold. In this example, the first subscription amount may be more than the second subscription amount. As such, the first performance threshold may be higher than the second performance threshold.

Although the content delivery system 100 includes both open and closed network paths, the topology of the open network may not be known. Accordingly, one or more embodiments of the present disclosure may be used to discover the topology of the open network provided by the internet service provider.

As the network analyzer 185 collects data from the various network data collection modules, additional access points, routers and/or paths of the open network may be discovered. For example and with reference to FIG. 1B, the network analyzer 185 may discover that the open network includes an additional access point. This additional access point is represented as Access Point 4 190 in FIG. 1B. Further, the network analyzer 185 may also discover network path segment 195 that connects Access Point 4 190 and Access Point 2 160.

As the topology of the open network is discovered by the network analyzer 185, different routes and/or network paths may be discovered and utilized. Continuing with the example from above, upon discovery of Access Point 4 190 and/or the performance characteristics of network path segment 195, Metrohead 1 130 may access the open network via Access Point 4 190 instead of Access Point 2 160. In other embodiments, Metrohead 1 130 may still access the open network via Access Point 2 160 but use network path segment 195 when delivering content due to its increased performance characteristics when compared with other network path segments. When a new access point is discovered, the various client devices may need to be updated with that information. In some embodiments, the network analyzer 185 may provide these updates. In other embodiments, the client devices may be updated by other modules within the content delivery system 100.

In another embodiment a single metrohead may access the open internet using different access points. For example, and turning to FIG. 1C, Metrohead 1 130 may access the open network via Access Point 2 160 and Access Point 4 190.

In some instances, additional metroheads may be added to the content delivery system 100. For example, and turning to FIG. 1D, Metrohead 4 196 may be added to the content delivery system 100. Metrohead 4 196 may be connected to Metrohead 1 130 via network path segment 197 and Metrohead 2 135 via network path segment 150. Metrohead 4 196 may be configured to access the open internet via Access Pont 2 160. Although specific examples are shown, additional metroheads and access points may be added at various points in the content delivery system 100.

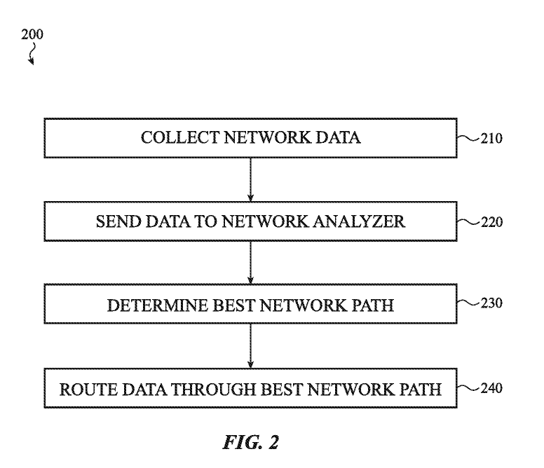

FIG. 2 illustrates a method 200 for determining and selecting a content delivery path in a content delivery system according to one or more embodiments. In some embodiments, the method 200 may be utilized by the content delivery system 100 described above with respect to FIGS. 1A-1D.

Method 200 begins at operation 210 in which data about a network, over which content is provided, is collected. For example, one or more client devices may be connected to the network and be configured to receive content from a content provider over the network. In some embodiments, the network is an open network provided by an internet service provider to its subscribers. The open network may include various network path segments that are interconnected through various routers, hubs, switches and so on. Each network path segment may have an associated performance characteristic. The performance characteristic may be latency and/or bandwidth of that particular network path segment.

In order for the content provider to provide content to the client devices, the network may have one or more access points through which the content provider may access the network. The content provider may then provide content to the one or more client devices. In some embodiments, the client device that is connected to the network is a set-top box. In some embodiments, the set-top box includes a network data collection module that periodically collects data about the network or collects data about particular portions of the network. For example, the network data collection module may periodically test bandwidth and latency of one or more network path segments of the network. The network data collection module may also collect data to determine a network topology of the network.

Once the data has been collected, flow proceeds to operation 220 and the data is sent to a network analyzer. In some embodiments, the network analyzer is associated with a headend or other component of the content provider.

Once the network analyzer has received the data, flow proceeds to operation 230 and the network analyzer analyzes the data to determine which network paths have performance characteristics that meet or exceed a performance threshold. In some embodiments, the network path segments that have performance characteristics that exceed the performance threshold may not make up the shortest path between the headend and a particular client device.

For example, the headend may route content though a geographic region that is not associated with a particular client device. Although the network path may be longer or otherwise follow a longer route, the selected network path may have better performance characteristics than a shorter path.

For example, the network analyzer may receive data from various client devices about various network path segments in the network. Using this data, the network analyzer may choose various network path segments that have performance parameters that exceed a threshold. In some embodiments, the determined network path may include portions of a closed network provided by the content provider and portions of the open network provided by the internet service provider.

For example, the network analyzer may determine that a particular headend associated with a particular geographic area may access the network using an access point that has particularly high performance threshold values. As such, content may be routed though that particular headend and access point regardless of the geographic area of the client device. In some embodiments, the alternate path may only include network path portions of the closed network.

Once the alternate network path is determined, flow proceeds to operation 240 and the content is delivered to the client device over the determined network path. In some embodiments, the network path segments that make up the alternate network path may be dynamically updated. As such, a network path from a headend to a client device may be constantly and dynamically change based on the collected data.

In other implementations, the network analyzer may determine that the original content delivery path is now performing above particular performance thresholds. As such, the network analyzer may again route content through that original network path.

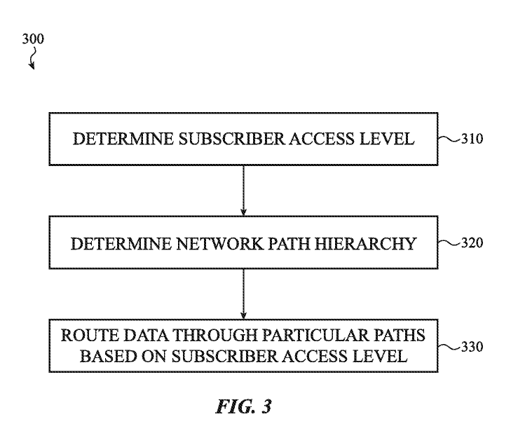

FIG. 3 illustrates a method for determining and selecting a content delivery path based, at least in part, on a subscription level of a subscriber to a subscription based content provider. The method 300 may be used by a content delivery system 100 such as described above. In addition, the method 300 may be used in conjunction with the method 200 previously described.

As discussed above, a client device may be configured to receive content from a content provider. The content may be provided to the client device over various network paths. In some implementations, alternate network paths may be selected based on performance characteristics of the network paths. Accordingly, method 300 describes a way in which the networks paths may be selected based on a subscription level of a subscriber.

As such, method 300 begins at operation 310 in which a subscriber access level is determined. In some embodiments, the subscriber access level may be provided by a client device to a network analyzer of the content provider. The network analyzer may track or otherwise have access to the various subscriber access levels of each client device.

The subscriber access level may be a tiered system in which different subscription payment amounts are associated with each tier. For example, a subscriber with a first access level may have a first monthly payment to access content from the content provider and a subscriber with a second access level may have a second monthly payment to access content from the content provider.

In some embodiments, each access level may be associated with various network performance characteristics. For example, a subscriber who has the first access level may receive content over various network paths that have first performance characteristics while the subscriber who has the second access level may receive content over various network paths that have second performance characteristics.

Using the network path characteristics described above, a network path hierarchy may be determined in operation 320. In some embodiments, a network analyzer may receive data from various client devices in order to determine the hierarchy. The network path hierarchy may consist of network path segments whose performance characteristics meet or exceed a performance characteristic threshold. Thus, network path segments that have performance characteristics that are above a first performance threshold may be used to provide content to subscribers having the first access level, while network path segments that have performance characteristics that meet or exceed a second performance threshold may be used to provide content to subscribers having the second access level.

Once the network path hierarchy is determined, flow then proceeds to operation 330 and content may be routed through particular paths to various client devices based on the subscriber access level.

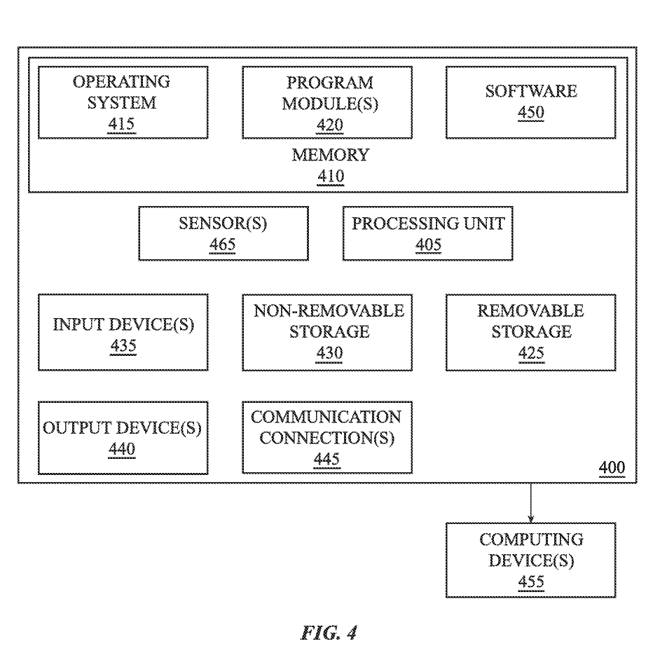

FIG. 4 illustrates an example computing device 400 that may be part of the content delivery system, such as, for example, content delivery system 100 described with respect to FIG. 1A. For example, the computing device 400 may be client device, part of a headend, a network analyzer and so on. Although various components of the computing device 400 are shown, connections and communication channels between each of the components are omitted for simplicity.

In a basic configuration, the computing device 400 may include at least one controller or processing unit 405 and an associated memory 410. The memory 410 may include, but is not limited to, volatile storage such as random access memory, non-volatile storage such as read-only memory, flash memory, or any combination thereof. The memory 410 may store an operating system 415 and one or more program modules 420 suitable for running software applications 450. The operating system 415 may be configured to control the computing device 400 and/or one or more software applications 450 being executed by the operating system 415. The program modules 420 or software applications 450 may include modules and programs for requesting data from various client devices, analyzing the data, determine alternate network paths and so on.

The computing device 400 may have additional features or functionality than those expressly described herein. For example, the computing device 400 may also include additional data storage devices, removable and non-removable, such as, for example, magnetic disks, optical disks, or tape. These storage devices are illustrated in FIG. 4 by removable storage 425 and a non-removable storage 430.

In certain embodiments, various program modules and data files may be stored in the memory 410. The program modules 420 and the processing unit 405 may perform processes that include one or more of the operations of method 200 and method 300 shown and described with respect to FIGS. 2-3.

The computing device 400 may include one or more input devices 435. The input devices 435 may include a keyboard, a mouse, a pen or stylus, a sound input device, a touch input device, and the like. The computing device 400 may also include one or more output devices 440. The output devices 440 may include a display, one or more speakers, a printer, and the like.

The computing device 400 also includes communication connections 445 that facilitate communications with additional computing devices 455. Such communication connections 445 may include internet capabilities, a RF transmitter, a receiver, and/or transceiver circuitry, universal serial bus (USB) communications, parallel ports and/or serial ports.

As used herein, the term computer-readable media may include computer storage media. Computer storage media may include volatile and nonvolatile media and/or removable and non-removable media for the storage of information. Examples include computer-readable instructions, data structures, and program modules. The memory 410, the removable storage 425, and the non-removable storage 430 are all examples of computer storage media. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400.

Embodiments of the present disclosure are described above with reference to block diagrams and operational illustrations of methods and the like. The operations described may occur out of the order as shown in any of the figures. Additionally, one or more operations may be removed or executed substantially concurrently. For example, two blocks shown in succession may be executed substantially concurrently. Additionally, the blocks may be executed in the reverse order.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A method for delivering content to a client device, comprising:
receiving, from the client device, data about at least a portion of a network path over which content is delivered to the client device;
analyzing the received data to determine one or more performance parameters of the at least the portion of the network path;
when the performance parameters of the at least the portion of the network path is below a performance threshold;
selecting an alternate network path; wherein
the alternate network path comprises a first network path portion from a first provider and a second network path portion from a second provider.

2. The method of claim 1, wherein the first provider is an internet service provider.

3. The method of claim 1, wherein the second provider is a subscription based content provider.

4. The method of claim 1, wherein the second network path portion is part of a closed network.

5. The method of claim 1, wherein selecting an alternate network path comprises selecting an alternate network path that has one or more performance parameters that are higher than the determined one or more performance parameters of the at least the portion of the network path.

6. The method of claim 1, further comprising:
determining one or more conditions associated with the at least the portion of the network path when the performance parameters of the at least the portion of the network path is below a performance threshold; and
automatically selecting the alternate network path when the one or more conditions are detected.

7. The method of claim 1, further comprising discontinuing use of the alternate network path when it is determined that the performance parameters of the at least the portion of the network path exceed the performance threshold.

8. A content delivery system, comprising:
a client device communicatively coupled to a first network, the client device comprising a network data collection module;
a content delivery module communicatively coupled to a second network and the first network; and
a network analyzer configured to:
receive network data from the network data collection module; and
determine, based at least in part, on the network data, a content delivery path, the content delivery path including network path segments from the first network and network path segments from the second network.

9. The content delivery system of claim 8, wherein the client device is a set-top box.

10. The content delivery system of claim 8, wherein the second network is a closed network.

11. The content delivery system of claim 8, wherein the first network is provided by an internet service provider.

12. The content delivery system of claim 8, wherein the content delivery module is communicatively coupled to the first network using an access point.

13. The content delivery system of claim 8, wherein the content delivery module is associated with a subscription based content provider.

14. The content delivery system of claim 13, wherein the network analyzer is further configured to determine the content delivery path based, at least in part, on the type of content provided on the content delivery path.

15. The content delivery system of claim 13, wherein the network analyzer is further configured to determine the content delivery path based, at least in part, on a subscription level associated with the client device.

16. A computer-readable storage medium encoding computer-executable instructions which, when executed by a processing unit, performs a method for dynamically selecting a content delivery path, comprising:
receiving performance data about at least a portion of the delivery path;
analyzing the received data to determine one or more performance parameters of the at least the portion of the delivery path; and
when the performance parameters of the at least the portion of the delivery path is below a performance threshold, selecting an alternate delivery path; wherein
the alternate delivery path comprises a first path portion from a first provider and a second path portion from a second provider.

17. The computer-readable storage medium of claim 16, further comprising instructions for receiving performance data about at least a portion of the alternate delivery path.

18. The computer-readable storage medium of claim 16, wherein the one or more performance parameters may be selected from a group comprising bandwidth and latency.

19. The computer-readable storage medium of claim 16, further comprising instructions for notifying a provider of the at least the portion of the delivery path that the performance parameters are below the performance threshold.

20. The computer-readable storage medium of claim 16, further comprising instructions for discontinuing use of the alternate delivery path when it is determined the performance parameters of the at least the portion of the delivery path is no longer below the performance threshold.
